(19) United States
(12) Patent Application Publication
(10) Pub. No.: US 2021/0089364 A1
(43) Pub. Date: Mar. 25, 2021

(54) WORKLOAD BALANCING AMONG COMPUTING MODULES

(71) Applicant: Microsoft Technology Licensing, LLC, Redmond, WA (US)

(72) Inventors: Garrett Douglas Blankenburg, Sammamish, WA (US); William Paul Hovis, Sammamish, WA (US); Andres Felipe Hernandez Mojica, Seattle, WA (US)

(21) Appl. No.: 16/579,154

(22) Filed: Sep. 23, 2019

(51) Int. Cl. G06F 9/50; G06F 11/30; G06F 11/34

(52) U.S. Cl. CPC G06F 9/5094; G06F 9/5083; G06F 11/3433; G06F 11/3062; G06F 9/5027

(57) ABSTRACT

Computing assemblies, such as blade servers, can be housed in rackmount systems of data centers for execution of applications for remote users. These applications can include games and other various user software. In one example, a method of operating a data processing system includes receiving requests for execution of a plurality of applications, and identifying estimated power demands for execution of each of the plurality of applications. The method also includes determining power limit properties for a plurality of computing modules capable of executing the plurality of applications, and selecting among the plurality of computing modules to execute ones of the plurality of applications based at least on the power limit properties and the estimated power demands.

### BACKGROUND

Networked storage and computing systems have been introduced which store and process large amounts of data in enterprise-class storage environments. Networked storage systems typically provide access to bulk data storage, while networked computing systems provide remote access to shared computing resources. These networked storage systems and remote computing systems can be included in high-density installations, such as rack-mounted environments. Various computing and storage solutions have been offered using large installations of high-density rack-mount equipment. In some instances, collections of integrated circuits, such as processor devices and peripheral circuitry employed in computing systems, can be integrated into modular equipment, referred to as blade servers. These blade servers are compact modular computing equipment that include a chassis and enclosure, as well as various cooling or airflow equipment. A large collection of the modular blade servers can be included in each rack of a rack-mount environment, to provide for multiple instances of similar hardware with a low physical footprint.

### Overview

Computing assemblies, such as blade servers, can be housed in rackmount systems of data centers for execution of applications for remote users. These applications can include games and other various user software. In one example, a method of operating a data processing system includes receiving requests for execution of a plurality of applications, and identifying estimated power demands for execution of each of the plurality of applications. The method also includes determining power limit properties for a plurality of computing modules capable of executing the plurality of applications, and selecting among the plurality of computing modules to execute ones of the plurality of applications based at least on the power limit properties and the estimated power demands.

This Overview is provided to introduce a selection of concepts in a simplified form that are further described below in the Detailed Description. It may be understood that this Overview is not intended to identify key features or essential features of the claimed subject matter, nor is it intended to be used to limit the scope of the claimed subject matter.

### BRIEF DESCRIPTION OF THE DRAWINGS

Many aspects of the disclosure can be better understood with reference to the following drawings. While several implementations are described in connection with these drawings, the disclosure is not limited to the implementations disclosed herein. On the contrary, the intent is to cover all alternatives, modifications, and equivalents.

FIG. 1 illustrates a computing environment in an implementation.

FIG. 2 illustrates a method of operating a control system in an implementation.

FIG. 3 illustrates a workload manager in an implementation.

FIG. 4 illustrates a method of operating a workload manager in an implementation.

FIG. 5 illustrates an example computing module and blade module in an implementation.

FIG. 6 illustrates a method of performance testing a computing system in an implementation.

FIG. 7 illustrates an example control system suitable for implementing any of the architectures, platforms, processes, methods, and operational scenarios disclosed herein.

### DETAILED DESCRIPTION

Networked computing systems can store and service large amounts of data or applications in high-density computing environments. Rack-mounted environments are typically employed, which includes standardizes sizing and modularity among individual rack units. For example, a 19″ rack mount system might include a vertical cabinet arrangement having a vertical height sufficient for 42 “unit” (U) sized modules coupled to an integrated rail mounting system. Other sizes and configurations of rack-mount systems can be employed. Various computing and storage solutions have been offered using large installations of these high-density rack-mount equipment. In some instances, individual computing units can be referred to as blade servers, which typically each comprise a computer/processor element along with network elements, storage elements, and other peripheral circuitry. These blade servers are compact modular computing equipment that include a chassis and enclosure, as well as various cooling or airflow equipment. A large collection of blade servers can be included in each rack of a rack-mount environment, to provide for multiple instances of similar hardware with a low physical footprint.

In one example rack-mount environment, exemplary blade computing assembly 115 includes a plurality of modular computer systems 130-131 which are placed onto a common circuit board or set of circuitry boards within a shared enclosure. Each of blade computing assemblies 111-115 can have a particular set of modular computing assemblies, which are also referred to herein as computing modules. Each of these modular computer systems 130-131 can be capable of independently executing an operating system and applications, and interfacing over network-based links with one or more end users or with one or more control systems. In a specific example, these modular computer systems might each comprise an integrated gaming system, such as an Xbox gaming system, formed into a single modular assembly. The individual modular computer systems can have system processors, such as system-on-a-chip (SoC) elements with processing cores and graphics cores, along with associated memory, storage, network interfaces, voltage regulation circuitry, and peripheral devices. Several of these gaming systems can be assembled into a blade computing assembly and packaged into an enclosure with one or more fan units. In one example below, eight (8) of these modular computer systems (having associated circuit boards) are assembled into a single 2U blade assembly. These modular computer systems might each comprise a separate Xbox One-S motherboard, so that 8 Xbox One-S motherboards are included in a single 2U-sized blade computing assembly. Then, multiple ones of these 2U blade arrangements can be mounted into a rack. A typical 40-48 “unit” (U) rack-mount system thus can hold 20-24 2U blade assemblies.

In many use cases for these networked computing systems, such as the rack-mount environments discussed above, the included modular computer systems can receive network-originated requests for processing or storage of data. The requests for execution of various software are referred to herein as workloads or tasks, and might comprise game streaming, video streaming, algorithm processing, neural network training and processing, cloud-based application execution, data storage tasks, data processing, and other various types of requested execution. These requests can originate internally to a data center, or might instead be received from external users requesting to run applications or store data.

Each computing module, such as computing modules 130-131, can have different maximum power dissipation limits or power ceilings which are determined in part by the particular variations in manufacturing, cooling, and assembly, among other factors. Thus, each of the blade computing assemblies can also have individual modular computer systems contained within which can each have variations in operational power dissipations for comparable workloads due to similar factors. These different maximum power dissipations among the computing modules can be related to operating voltages for at least processing elements of the computing modules. Characterizations of each computing module under a common or similar workload are performed to determine minimum operating voltages (Vmin) for each of the computing modules. The minimum operating voltages correspond to a lowest operating voltage during performance testing for processing elements of a computing module before failure of the processing elements, along with any applicable safety margin or other margins. Typically, these Vmin values will vary for each computing module, with some computing modules having relatively high operating voltages, and some computing modules having relatively low operating voltages. Various binning or categorization of these performance-tested computing modules can be established based on results of the performance tests. In many examples, the Vmin values will be related to a power limit or maximum power dissipation of the computing modules under a standardized load established by the performance testing, which can occur during manufacturing processes of the computing modules or blade computing assemblies. This maximum power dissipation might correspond to a thermal design power (TDP) of the computing modules, adjusted according to the performance testing-derived Vmins.

In the examples herein, knowledge of variations in operational power dissipations across different workloads as well as maximum power dissipation limits are managed to better optimize power dissipation locality and thermal loading within a rack-mount environment. For example, when a rack-mount computing system receives requests to execute applications or games for remote users, then enhanced operation can be obtained for blade computing assemblies within the rack-mount environment. For example, a management node or control system can advantageously distribute incoming workloads or tasks to being run in a specific rack, blade, or even computing module within a blade. Power and airflow for enterprise-level computing systems are typically specified as a ratio of airflow to power consumed by a rack in cubic feet per minute per kilowatt (CFM/kW). In the examples herein, a blade computing assembly that is dropping away from a particular CFM/kW requirement could be assigned to run additional and/or more demanding workloads. Alternatively, as a blade computing assembly starts to run consistently at or above a CFM/kW requirement, the blade computing assembly could be assigned a lighter workload to return closer to the CFM/kW requirement. As a result of this operation, each blade computing assembly can operate closer to optimal power and thermal targets, while maximizing usage among a plurality of blade computing assemblies. Moreover, energy costs are many times paid in advance for data centers, and it can be advantageous to operate blade computing assemblies close to maximum capacity.

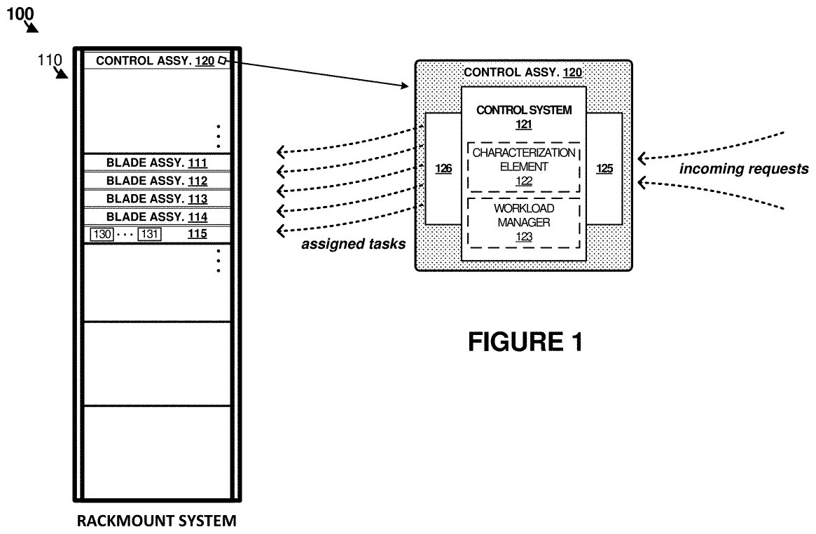

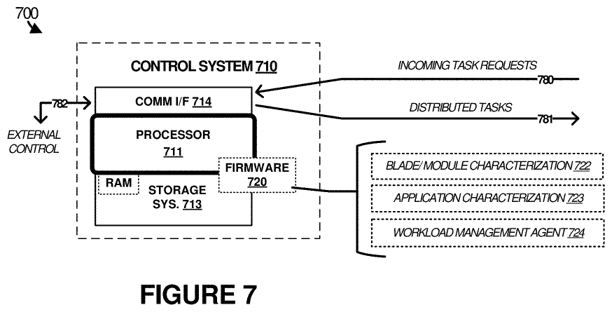

Turning now to a first example, FIG. 1 is presented. FIG. 1 illustrates computing environment 100. Computing environment 100 includes rackmount system 110 having a plurality of blade computing assemblies 111-115 coupled therein, as well as control assembly 120. Although the examples herein do not require installation into a rackmount system, environment 100 includes rackmount system 110 for context and clarity. Each blade computing assembly 111-115 can comprise multiple modular computer systems, referred to as computing modules herein, and represented by computing modules 130-131 in blade computing assembly 115. FIG. 7 illustrates an example computing module and blade computing assembly with several computing modules.

As mentioned above, each blade computing assembly 111-115 can include a plurality of computing modules. Blade computing assemblies 111-115 also each include airflow elements, communication systems, and communication links. Blade computing assemblies 111-115 might communicate with external systems over an associated network link, which may include one or more individual links. Furthermore, blade computing assemblies 111-115 can include power elements, such as power filtering and distribution elements to provide each associated computing module with input power. Blade computing assemblies 111-115 can each comprise a single circuit board or may comprise a circuit board assembly having one or more circuit boards, chassis elements, connectors, and other elements. Blade computing assemblies 111-115 can include connectors to individually couple to computing modules, as well as mounting elements to fasten computing modules to a structure, circuit board, or chassis. Blade computing assemblies 111-115 can each be included in an enclosure or case which surrounds the various elements of the blade and provides one or more apertures for airflow.

Example computing module included in blade computing assemblies 111-115 comprises a system processor, such as a CPU, GPU, or an SoC device, as well as a power system having voltage regulation circuitry. Various network interfaces including network interface controller (NIC) circuitry, and various peripheral elements and circuitry can also be included in each computing module. The computing modules included in a blade are typically the same type of module or uniform type of module having similar capabilities. Some computing modules might comprise similar types of modules comprising functionally compatible components, such as when updates or upgrades are made to individual computing modules or blades over time. Thus, any computing module can be swapped for each other and failed ones among the computing modules of blade computing assemblies 111-115, and can be replaced with a common type of module which couples using a common type of connector.

Airflow elements can be included in each of blade computing assemblies 111-115 and rackmount system 110 which comprise one or more fans, fan assembles, fan elements, or other devices to produce an airflow over blade computing assemblies 111-115 for removal of waste heat from at least the associated computing modules. Airflow elements can comprise any fan type, such as axial-flow, centrifugal and cross-flow, or other fan types, including associated ducts, louvers, fins, or other directional elements, including combinations and variations thereof. Airflow provided by airflow elements can move through one or more perforations or vents in an associated enclosure that houses blade computing assemblies 111-115 and associated computing modules.

Control assembly 120 comprises control system 121, and a network communication system comprising external network interface 125 and rack network interface 126. Control system 121 comprises characterization element 122 and workload manager 123. Control system 121 comprises one or more computing elements, such as processors, control circuitry, and similar elements, along with various storage elements. Control system 121 executes characterization element 122 and workload manager 123 to perform the various enhanced operations discussed herein. External network interface 125 and rack network interface 126 each comprise one or more network interface controllers (NICs), along with various interconnect and routing equipment. Typically, external network interface 125 couples over one or more packet network connections to external systems or to further network routers, switches, or bridges that receive traffic from one or more external systems. Rack network interface 126 couples over packet network connections to each of blade computing assemblies 111-115 within rackmount system 110.

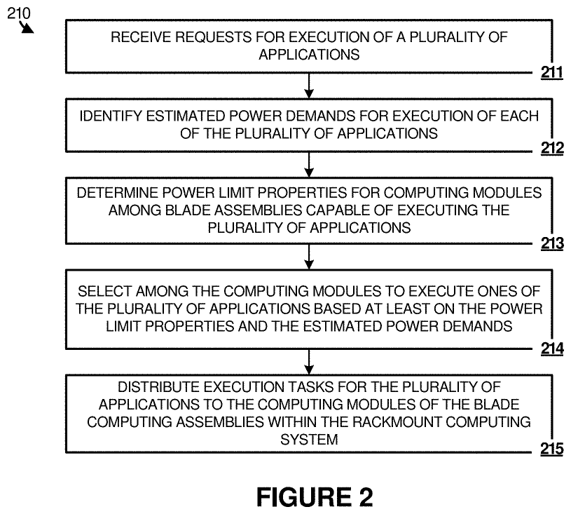

In operation, control system 121 receives requests for execution of tasks, such as games or applications, from external users over external network interface 125. These requests can be issued by various users from across various external networks, such as the Internet, wide-area networks (WANs), and other network-based entities. Workload manager 123 can determine selected blade computing assemblies to distribute the tasks for handling. Workload manager 123 can perform these selections based in part on power limit properties determined previously for computing modules within blade computing assemblies 111-115, as well as on currently dissipated power for each of blade computing assemblies 111-115. Moreover, workload manager 123 considers the estimated power consumption or workload for each task when distributing the tasks to blade computing assemblies 111-115. Characterization element 122 can perform various operations to determine power limits properties for computing modules in each of blade computing assemblies 111-115. Moreover, characterization element 122 can determine estimated workloads for individual tasks, such as power estimates for executing various games, applications, and other software elements. A more detailed discussion on the operation of control assembly 120 is included in FIG. 2.

FIG. 2 illustrates a method of operating a control system in an implementation. Operations 210 of FIG. 2 are discussed in the context of control system 121 in rackmount system 110 of FIG. 1, but the operations can be applied to any of the control systems, workload managers, or management agents discussed herein. As mentioned above, FIG. 1 includes blade computing assemblies 111-115 that can service user requests to execute applications, such as games or other user applications. However, instead of interfacing directly with the user requests, blade computing assemblies 111-115 each couple to control assembly 120 which instead receives (211) requests for execution of a plurality of applications. Control assembly 120 might comprise a top-of-rack assembly which couples over one or more network connections to external systems and networks. Control assembly 120 receives these requests and the distributes the requests for handling by individual ones of blade computing assemblies 111-115.

However, control assembly 120 performs one or more enhanced operations when selecting which among blade computing assemblies 111-115 should handle each request. First, control system 121 of control assembly 120 identifies (212) estimated power demands for execution of each of the plurality of applications. These estimated power demands can be based on prior execution of the applications to determine power consumption characteristics for a computing system that executes the applications. A predetermined set of applications can be pre-characterized in this manner to determine power consumption characteristics, which might be performed on a representative computing system or more than one representative computing system to determine average or statistically relevant power consumption characteristics. Once the power consumption characteristics are determined for each application which is characterized, then quantified measurements of power consumption characteristics can be used as absolute values, such as in watts (W), or the measurements might be normalized to a metric. This metric might comprise a percentage of a standardized power limit, such as percentage of a thermal design power (TDP) of a representative computing module or standardized computing module. Each application might have a corresponding quantity in the metric which represents an estimated power consumption. Thus, applications can be compared among each other according to a similar scale when selections are made to distribute requests for execution of the applications to blade computing assemblies 111-115.

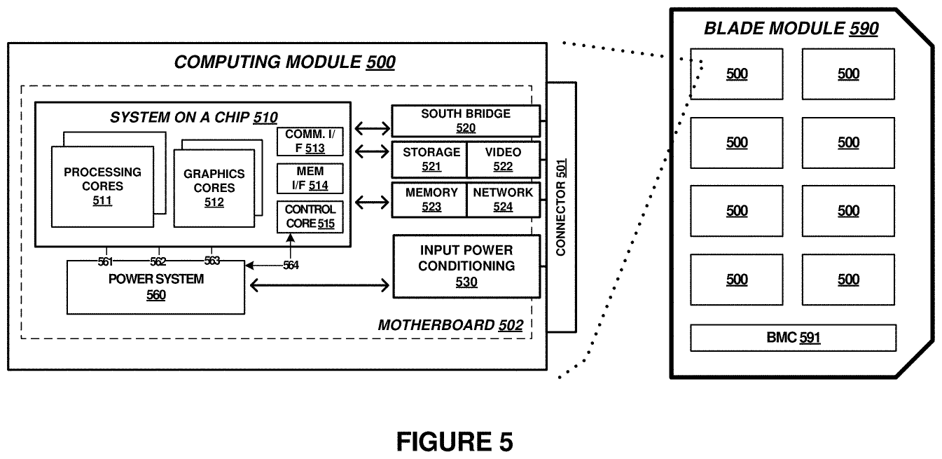

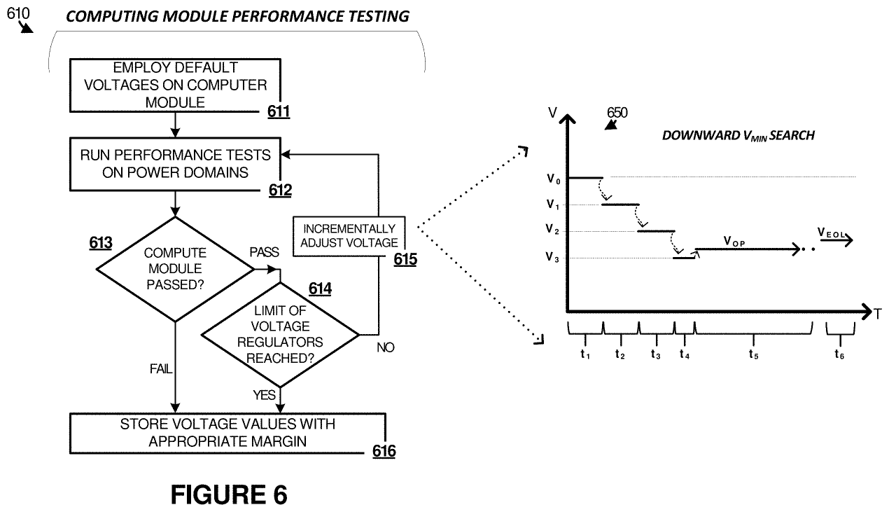

Next, control system 121 determines (213) power limit properties for a plurality of computing modules among a plurality of computing assemblies (e.g. blade computing assemblies 111-115) capable of executing the plurality of applications. Each computing module of each blade computing assembly can report power limit properties and also status information, such as operating temperatures, current draws, operating voltage levels, or other information. Control system 121 can identify previously determined power limits for each computing module of blade computing assemblies 111-115. The power limits can be determined using one or more performance tests executed by each computing module of blade computing assemblies 111-115. Maximum power dissipations for each of blade computing assemblies 111-115 can be determined using standardized performance tests which establish voltage minimum (Vmin) levels for at least processing elements of the computing modules. Variations in manufacturing, assembly, location within the rack, cooling/ventilation, and individual components can lead to differences among power dissipations and resultant heat generation which can play into Vmin levels for each computing module. Operating voltages for individual computing modules can be determined to have each computing module operate at a minimized or lowered operating voltage for associated CPUs, GPUs, and other peripheral components. This lowering of operating voltages can lead to a lower power dissipation for a given workload, in addition to the variations of each blade computing assembly due to variations in manufacturing, assembly, location within the rack, cooling/ventilation. A more detailed discussion on the determination of individual operating voltages for computing modules of blade computing assemblies is discussed in FIGS. 5-6 below.

Control system 121 then selects (214) computing modules among blade computing assemblies 111-115 to execute ones of the plurality of applications based at least on the power limit properties and the estimated power demands. Each application will have a corresponding estimated power to execute, and each computing module among blade computing assemblies 111-115 will have corresponding power limit properties. Control system 121 can select computing modules among blade computing assemblies 111-115 based on relationships between the power limit properties and the estimated power of an application. When many requests for applications are received, as well as many applications being presently executed, then each of blade computing assemblies 111-115 might have several applications being executed thereon. Control system 121 can intelligently select computing modules among blade computing assemblies 111-115 for new/incoming applications to be executed to optimize for power dissipations among blade computing assemblies 111-115.

Control system 121 might select among the computing modules of all blade computing assemblies, or might first select a particular blade computing assembly followed by a computing module within that selected blade computing assembly. In one example, if a blade computing assembly has sufficient overhead in a remaining power overhead to accommodate execution of a new application, then control system 121 can select a computing module within that blade computing assembly for execution of the application according to the incoming request. Selection of a particular computing module within a selected blade computing assembly can consider averaging power dissipation of computing modules among the executed applications of the blade computing assembly. For example, an application with a higher relative estimated power demand can be distributed for execution by a computing module with a lower relative power limit. Likewise, an application with a lower relative estimated power demand can be distributed for execution by a computing module with a higher relative power limit. This example can thus distribute applications to computing modules in a manner that will average out power consumption across computing modules, and ultimately across blade computing assemblies

If more than one blade computing assembly meets the criteria for execution of an application, then a secondary selection process can occur, such as round-robin, sequential, hashed selections, or according to thermal considerations. When thermal considerations are employed in the selection process, blade computing assemblies with the lowest present power dissipation can be selected before blade computing assemblies with higher present power dissipations. Alternatively, when thermal considerations are employed, then blade computing assemblies with the largest remaining power overheads might be selected before blade computing assemblies with smaller remaining power overheads. These power overheads can relate to a difference between a present power dissipation and power limits determined previously for the blade computing assemblies, or based on the power limits of individual computing modules of the blade computing assemblies.

Once individual blade computing assemblies are selected and individual computing modules are selected within the blade computing assemblies, then control system 121 distributes (215) execution tasks for the plurality of applications to selected computing modules among blade computing assemblies 111-115 within rackmount computing system 110. This distribution can occur via rack network interface 126. In some examples, control system 121 merely passes along the incoming requests as-received for application execution to the selected blade computing assemblies. In other examples, control system 121 alters the requests to include identifiers for the selected blade computing assemblies, such as to alter a media access control (MAC) address or other network address of a NIC associated with the selected blade computing assemblies. Task numbering or application identifiers might also be tracked by control system 121 to aid in tracking of present power dissipations of each blade computing assembly. In addition, each blade computing assembly can report current power dissipations periodically to control system 121 so that determinations on power limits and present power dissipations can be made.

In the above examples, control system 121 can consider power properties of individual computing modules within blade computing assemblies 111-115 for distribution of the application execution tasks. For example, some computing modules might have a lower power usage for comparable workloads than other computing modules. This lower power usage can be due in part to lower operating voltages which are determined during a performance testing, such as seen in FIG. 6. Thus, for a given workload, a first computing module might dissipate less power in a processing core than a second computing module. Control system 121 can consider these factors when distributing the tasks for application execution. One possible distribution example would distribute applications with higher estimated power demands to computing modules with lower power limits (measured in TDP), and distribute application with lower estimated power demands to computing modules with higher TDPs. These TDPs can be resultant from determining Vmin operating voltage levels among computing modules, along with various manufacturing variability. Reporting of the TDPs for each computing module of each of blade computing assemblies 111-115 can be performed upon boot or after associated performance testing. Control system 121 can then track which computing modules have current workloads and which computing modules are idle, and assign workloads to idle computing modules according to the TDPs and estimated power demands of the applications.

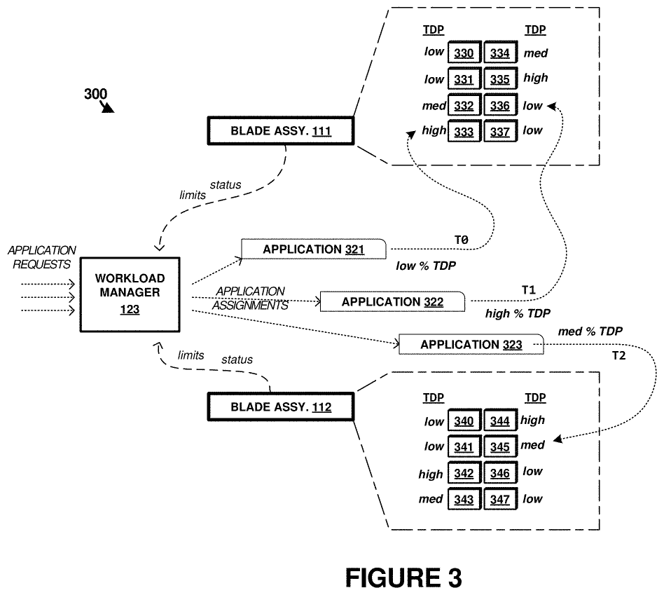

FIG. 3 is a diagram illustrating further operations for workload manager 123 and control system 121 in FIG. 1. In FIG. 3, application requests are received by workload manager 123 which processes the requests to select computing modules among blade computing assemblies 111-115 for handling of the requests. Each of blade computing assemblies 111-115 can identify previously determined power limit properties for each associated computing module, such as by having each computing module report stored power limit properties upon boot or periodically. Also, during handling of requests and execution of applications, each of blade computing assemblies 111-115 can transfer status information to workload manager 123 comprising present power dissipations among other information discussed herein. Workload manager 123 processes previously determined power limit properties for each of blade computing assemblies 111-115 and the amount of power estimated to execute each application to select computing modules among blade computing assemblies 111-115.

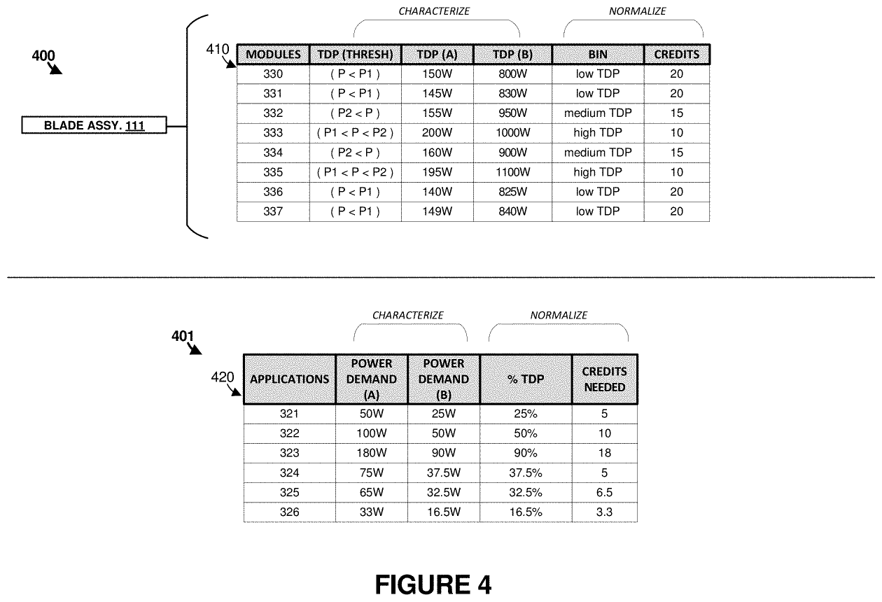

In FIG. 3, a request for execution of application 321 is received at time T0, and workload manager 123 performs a selection process for a computing module to execute application 321. First, workload manager 123 identifies an estimated power demand for execution of application 321. Application 321 is estimated to draw a “low” amount of power demand, which is a relative term used in this example for simplicity, along with “medium” and “high” relative power draws. FIG. 4 details more precise quantities for power demand. In FIG. 3, this low power demand is normalized into a metric or percentage of a metric, which in this example comprises certain percentage (%) of a maximum power limit for a representative computing module. For example, if a maximum power limit for a computing module is 1000 watts (W), then a certain percentage of that power limit would correspond to a portion of that power limit estimated for execution of the application. A specific example of a power limit includes a thermal design power (TDP) which indicates a maximum power dissipation for a computing module. This power limit or TDP can be determined by a characterization process or performance testing, such as those discussed herein.

Workload manager 123 processes this estimate power demand (in % TDP) against characterized power limits (in TDP) for each available computing module in a selected blade computing assembly. For blade computing assembly 111 comprising computing modules 330-337, each computing module will have a corresponding power limit. These are shown in FIG. 3 as relative power limits of “low,” “medium,” and “high”. In practice, the power limits can be represented in values of a designated metric, such as TDP. It should be understood that different representations of power limits can be employed. Various criteria can be used to select a computing module, such as random, round-robin, least-used, and the like. However, in FIG. 3 a power averaging selection process is employed. This power averaging process preferentially selects “low” % TDP applications to be executed by “high” TDP computing modules, and vice versa. Thus, for application 321, workload manager 123 selects one among the “high” TDP computing modules in blade computing assembly 111, namely computing module 333.

At a later time, T1, a request for execution of application 322 is received, and workload manager 123 determines which computing module should execute application 322. In this case, application 322 is determined to have an estimated power demand of a “high” % TDP. To satisfy the power averaging selection process employed in FIG. 3, workload manager 123 preferentially selects “high” % TDP applications to be executed by “low” TDP computing modules. Thus, for application 322, workload manager 123 selects one among the “low” TDP computing modules in blade computing assembly 111, namely computing module 336. At another later time, T2, a request for execution of application 323 is received, and workload manager 123 determines which computing module should execute application 323. In this case, application 323 is determined to have an estimated power draw of a “medium” % TDP. To satisfy the power averaging selection process employed in FIG. 3, workload manager 123 preferentially selects “medium” % TDP applications to be executed by “medium” TDP computing modules. Thus, for application 323, workload manager 123 selects one among the “medium” TDP computing modules in blade computing assembly 112, namely computing module 345. The selection of blade computing assembly 112 instead of blade computing assembly 111 can occur due to various factors. For example, blade computing assembly 111 might not have any further idle computing modules, or blade computing assembly 112 might have a preferred characteristic over blade computing assembly 111. These preferred characteristics might include current total power dissipation among all computing modules of the blade computing assembly, or another ordered/sequential selection process. Additional requests for applications can be handled in a similar manner as shown for applications 321, 322, and 323.

In FIG. 3, a power credit based system might be employed for distribution of applications among computing modules and associated blade computing assemblies. Example values for credits among both computing module TDPs and power demands for applications are shown in FIG. 4. Using this credit system, in FIG. 3, a request for execution of application 321 is received, and workload manager 123 determines that application 321 would require a certain quantity of “credits” of power for execution. These credits comprise a normalized metric for estimated power demand by an application when executed by a computing assembly. The quantity of credits for each application can be determined using a process discussed in FIG. 4 below. Each computing assembly within a blade computing assembly might have a corresponding TDP expressed in power credits, which can vary according to the power binning or power characterization previously performed for the computing modules. As applications are allocated for execution to a blade computing assembly, then these power credits are consumed or occupied by the applications according to the estimated power demands of the applications expressed in credits. For example, blade computing assembly 111 initially (time=T0) has a first quantity of power credits available based on an aggregate quantity corresponding to the included computing modules. Blade computing assembly can be determined to have sufficient remaining power credits (power overhead) to execute application 321, and workload manager 123 selects blade computing assembly 111 for execution of application 321. After workload manager 123 transfers a task assignment for execution of application 321 to a computing module of blade computing assembly 111, then that computing module of blade computing assembly 111 can execute application 321. The selection of actual computing modules within blade computing assembly 111 can occur as discussed above. A new remaining quantity of power credits or remaining power overhead for blade computing assembly 111 can be determined based on the initial quantity minus the credits required for application 321 to be executed, and thus blade computing assembly 111 might have fewer power credits remaining for further application execution (time=T1).

Later, a request for execution of application 322 is received, and workload manager 123 determines that application 322 would require a corresponding quantity of power credits for execution. Blade computing assembly 111 at time=T1 has fewer power credits available than at time=T0, while blade computing assembly 112 might still have an initial or maximum quantity of power credits. Only one among blade computing assemblies 111-112 might have sufficient remaining power credit overhead to execute application 322. Workload manager 123 selects a blade computing assembly for execution of application 322 based on credit availability and the required credits to execute application 322. After workload manager 123 transfers a task assignment for execution of application 322 to a selected blade computing assembly, then an included computing module can execute application 322. A new remaining power overhead for the selected blade computing assembly can be determined based on the previous overhead minus the new application 322 to be executed. For example, if blade computing assembly 111 is selected for execution of application 322, blade computing assembly 111 will have even fewer power credits remaining for further execution (time=T2).

Then, a request for execution of application 323 is received, and workload manager 123 determines that application 323 would require a corresponding quantity of power credits for execution. Blade computing assembly 111 at time=T2 has a certain quantity of power credits available, while blade computing assembly 112 still has an initial or maximum quantity of power credits available. In this example, blade computing assembly 112 might sufficient remaining power credit overhead to execute application 323, while blade computing assembly 111 might not, and thus workload manager 123 selects blade computing assembly 112 for execution of application 323. After workload manager 123 transfers a task assignment for execution of application 323 to blade computing assembly 112, then an included computing module can execute application 323. A new remaining power overhead for blade computing assembly 112 can be determined based on the previous overhead minus the new application 323 to be executed, and thus blade computing assembly 112 will have fewer power credits remaining for further execution (time=T3). Other requests can be received for execution of further applications or for further instances of the same applications, and similar processes can be followed for selection among blade computing assemblies 111-115 for execution of those applications. Moreover, as applications are terminated, execution completes, or applications idle then workload manager 123 can update the remaining power overheads to account for increases in remaining power overhead.

FIG. 4 is a diagram illustrating operations for characterization element 122 and control system 121 in FIG. 1. In FIG. 4, characterization of power limits for computing modules of blade computing assemblies and characterization of estimated power demands for applications can be determined. The application characterizations are typically performed before execution of applications or responsive to introduction of a new type of application to execute. The characterizations of computing modules can be performed during manufacturing of the computing modules, during assembly into the blade computing assemblies, or periodically. Although various numerical values for power and percentages are shown in FIG. 4, it should be understood that these values are merely exemplary and will vary based on exact hardware, software, and other implementation-specific details.

In operations 400, computing modules of blade computing assemblies are characterized to determine maximum power capability or power limits. Empirical testing can be performed on each of the computing modules which comprise each blade computing assembly to determine a power limit. A characterization process can thus include execution of standardized power performance tests on each computing module that comprises a blade computing assembly. Since power efficiency of each computing module can vary according to manufacturing, assembly, and component selections, this characterization process can lead to more effective and accurate power limits for each computing module. FIGS. 5-6 discuss performance testing based characterization on a per-computing module basis. In FIG. 4, power limit testing results are shown for computing modules 330-337 of blade computing assembly 111, with each computing module having a corresponding power limit. In table 410, two example power regimes are illustrated for different types of computing modules. In a first example noted by TDP(A), computing modules are employed which vary in power consumption (rated in TDP) from 140 watts (W) to 200 W for a given workload. In a second example noted by TDP(B), computing modules are employed which vary in power consumption from 800 W to 1100 W for a given workload. These example power consumption quantities correspond to a power limit, such as TDP, for each computing module running a common or standardized workload, and can represent power dissipation for each computing module under the standardized workload, which can vary due in part the power efficiency of the computing module. In addition to the specific numerical values in table 410, various threshold ranges are shown for a power consumption (P) between thresholds (P1 and P2). These thresholds can be used to bin or sort each computing module according to predetermined power consumption ranges (such as indicated for the ‘bin’ column that corresponds to normalized high, medium, and low TDP metrics).

Once the computing module performance testing produces an individualized power limit for each computing module, then that power limit can be normalized to a power metric, similar to what was discussed in FIG. 3. In this example, the power metric comprises a thermal design power (TDP), which indicates a maximum power under load that the computing module dissipates. Although the scale used for the metric in FIG. 4 is listed in relative terms of low, medium, and high, it should be understood that different metric representations can be used. In some examples, the normalization step can be omitted, and the characterized power can correspond to the TDP or metric.

Once the computing modules are assembled into a blade computing assembly, then the blade computing assembly might have a power limit or TDP determined. To determine the total power limits for a blade computing assembly, the power limits might be determined from mathematical additions among power limits of computing modules that comprise each blade server assembly. For example, when eight computing modules are mounted within each blade computing assembly, then the total power limits for each computing module can be added together for a total applicable to the particular blade computing assembly. Additional power dissipation can be accounted for by other support components in the blade computing assembly, such as power supply components, cooling/ventilation components, blade management components, communication interfaces, indicator lights, and the like.

The power limit can also be normalized to a power credit based metric. In this example, the bin values are correlated to a credit allotment for each computing module. The credit allotment indicates a greater quantity of credits for ‘low’ power consumption computing modules and a lesser quantity of credits for ‘high’ power consumption computing modules. This arrangement can reflect that lower power consumption computing modules are selected to handle execution of higher power demand applications for a given thermal output or percentage of power consumption, while higher power consumption computing module are selected to handle execution of lower power demand applications. Thus, a ‘low’ normalized TDP can correspond to 20 credits, a ‘medium’ normalized TDP can correspond to 15 credits, and a ‘high’ normalized TDP can correspond to 10 credits. Other granularities and binning might instead be employed. For example, a direct or scaled proportion of TDP values to credits might be employed. These credits can then be used as power limits and initial power overheads for each computing module. Blade computing assemblies that include these computing modules can have aggregate credits determined among the included computing modules, and these aggregate credits can be reported to a control system which monitors power usage among the blade computing assemblies.

Operations 401 are related to characterization of individual application types to determine expected or estimated power demand for each application. In table 420, applications 321-326 are shown as representing a different application type, which might comprise different games, productivity applications, software operations, or other user-initiated processing task. Each application, when executed, can have a different level of power dissipation which might include peak power dissipations, average power dissipations, and minimum power dissipations, among other measurements of power dissipations. Moreover, this power dissipation can vary across different computing systems which perform the execution. Thus, the characterization process can not only take into account measurements of power required to execute a particular application, but also variation among a representative sample of execution systems. These execution systems might include the computing modules that comprise each blade computing assembly, among other computing systems. Representative software, such as operating systems, can also be employed which might also have variations due to versioning or installed modular components. However, for each application, an estimated power demand is determined, which comprises an estimated power dissipation for execution of the application on one or more representative execution systems.

Once the per-application characterization produces an estimated power demand for each application type in absolute power terms (e.g. watts), then those estimated power demands can be normalized to a power based metric, similar to what was discussed above. A standardized or representative power limit for a computing module can be used as a basis for a metric, and each application power demand can be determined as a percentage of this metric. For the examples in operations 201, a representative computing module might have a TDP or maximum power limit of a particular power limit measured in watts. A first example configuration of applications, noted by power demand (A) in table 420, has first corresponding measured power demands that vary from 33 W to 180 W. This first example configuration has a maximum power limit of 200 W. A second example configuration of applications, noted by power demand (B) in table 420, has second corresponding measured power demands from 16.5 W to 90 W. This second example configuration has a maximum power limit of 100 W.

An application might be characterized and then normalized as using a certain percentage of the maximum power limit of the representative computing module, such as maximum power limits of 200 W for the first configuration or 100 W for the second configuration. Each application can be correspondingly normalized as a percentage of power demand of the power limit. The estimated power demands can also be normalized to a power credit based metric, similar to that discussed above. The first configuration has the metric of 10 watts per credit, and each estimated power demand for each application will have an associated credit which varies as shown from 3.3 credits to 18 credits, with a theoretical range of 1-20 in this example. The second configuration has the metric of 5 watts per credit, and each estimated power demand for each application will have an associated credit which varies as shown from 3.3 credits to 18 credits, with a theoretical range of 1-20 in this example. Other granularities and credit allotments might instead be employed. These credits can then be used as when selecting among computing modules and blade computing assemblies for execution of such applications.

Turning now to an example of the computing modules discussed herein, FIG. 5 is presented. FIG. 5 includes computing module 500 and blade module 590. Computing module 500 can be used to implement computing modules found in blade computing assemblies 111-115 in FIG. 1, although variations are possible. Examples of computing module 500 include modularized versions of various computer-based systems. These can include, but are not limited to, gaming systems, smartphones, tablet computers, laptops, servers, customer equipment, access terminals, personal computers, Internet appliances, media players, or some other computing apparatus, including combinations thereof. In a specific example, computing module 500 can comprise an Xbox gaming system modularized onto a single circuit board or multiple circuit boards that communicate over a shared connector 501 and couple to a main board or motherboard of blade module 590. The modularized Xbox gaming system can be configured to remotely service interactive gaming applications to end users over one or more network links carried by connector 501.

Blade module 590 illustrates an example blade computing assembly, such as any of blade computing assemblies 111-115 in FIG. 1, although variations are possible. Blade module 590 includes eight (8) computing modules 500 and blade management controller (BMC) 591. Blade module 590 can also include various power distribution elements, communication and networking interconnect, connectors, indicator lights, fan assemblies, ventilation features, and other various components. Typically, blade module 590 will have a chassis and a motherboard to which individual computing modules 500 are mounted. An enclosure can provide physical protection for computing modules 500 as well as direct airflow over computing modules 500.

BMC 591 includes processing and interfacing circuitry which can monitor status for individual elements of blade module 590. This status can include temperatures of various components and enclosures, power dissipation by individual ones of computing modules 500, operational status such as pass/fail state of various components, among other information. BMC 591 can communicate over a network interface, such as Ethernet, or alternatively over a discrete interface or system management serial link. In examples such as FIG. 1, a BMC of each blade computing assembly can periodically provide status including power dissipation to control system 121.

Computing module 500 may be implemented as a single apparatus, system, or device or may be implemented in a distributed manner as multiple apparatuses, systems, or devices. Computing module 500 includes, but is not limited to, system on a chip (SoC) device 510, south bridge 520, storage system 521, display interfaces 522, memory elements 523, network module 524, input power conditioning circuitry 530, and power system 560. SoC device 510 is operatively coupled with the other elements in computing module 500, such as south bridge 520, storage system 521, display interfaces 522, memory elements 523, network module 524. SoC device 510 receives power over power links 561-563 as supplied by power system 560. One or more of the elements of computing module 500 can be included on motherboard 502, although other arrangements are possible.

Referring still to FIG. 5, SoC device 510 may comprise a micro-processor and processing circuitry that retrieves and executes software from storage system 521. Software can include various operating systems, user applications, gaming applications, multimedia applications, or other user applications. SoC device 510 may be implemented within a single processing device, but may also be distributed across multiple processing devices or sub-systems that cooperate in executing program instructions. Examples of SoC device 510 include general purpose central processing units (CPUs), application specific processors, graphics processing units (GPUs), and logic devices, as well as any other type of processing device, combinations, or variations thereof. In FIG. 5, SoC device 510 includes processing cores 511, graphics cores 512, communication interfaces 513, memory interfaces 514, and control core 515, among other elements. Some of the noted elements of SoC device 510 can be included in a north bridge portion of SoC device 510.

Control core 515 can instruct voltage regulation circuitry of power system 560 over link 564 to provide particular voltage levels for one or more voltage domains of SoC device 510. Control core 515 can instruct voltage regulation circuitry to provide particular voltage levels for one or more operational modes, such as normal, standby, idle, and other modes. Control core 515 can receive instructions via external control links or system management links, which may comprise one or more programming registers, application programming interfaces (APIs), or other components. Control core 515 can provide status over various system management links, such as temperature status, power phase status, current/voltage level status, or other information.

Control core 515 comprises a processing core separate from processing cores 511 and graphics cores 512. Control core 515 might be included in separate logic or processors external to SoC device 510 in some examples. Control core 515 typically handles initialization procedures for SoC device 510 during a power-on process or boot process. Thus, control core 515 might be initialized and ready for operations prior to other internal elements of SoC device 510. Control core 515 can comprise power control elements, such as one or more processors or processing elements, software, firmware, programmable logic, or discrete logic. Control core 515 can execute a voltage minimization process or voltage optimization process for SoC device 510. In other examples, control core 515 can include circuitry to instruct external power control elements and circuitry to alter voltage levels provided to SoC device 510, or interface with circuitry external to SoC device 510 to cooperatively perform the voltage minimization process or voltage optimization process for SoC device 510.

Control core 515 can comprise one or more microprocessors and other processing circuitry. Control core 515 can retrieve and execute software or firmware, such as firmware comprising power phase control firmware, power monitoring firmware, and voltage optimization or minimization firmware from an associated storage system, which might be stored on portions of storage system 521, RAM 523, or other memory elements. Control core 515 can be implemented within a single processing device but can also be distributed across multiple processing devices or sub-systems that cooperate in executing program instructions. Examples of control core 515 include general purpose central processing units, application specific processors, and logic devices, as well as any other type of processing device, combinations, or variations thereof. In some examples, control core 515 comprises a processing core separate from other processing cores of SoC device 510, a hardware security module (HSM), hardware security processor (HSP), security processor (SP), trusted zone processor, trusted platform module processor, management engine processor, microcontroller, microprocessor, FPGA, ASIC, application specific processor, or other processing elements.

Data storage elements of computing module 500 include storage system 521 and memory elements 523. Storage system 521 and memory elements 523 may comprise any computer readable storage media readable by SoC device 510 and capable of storing software. Storage system 521 and memory elements 523 may include volatile and nonvolatile, removable and non-removable media implemented in any method or technology for storage of information, such as computer readable instructions, data structures, program modules, or other data. Examples of storage media include random access memory (RAM), read only memory, solid state storage devices, magnetic disks, optical disks, flash memory, virtual memory and non-virtual memory, magnetic storage devices, or any other suitable storage media. Storage system 521 may comprise additional elements, such as a controller, capable of communicating with SoC device 510 or possibly other systems.

South bridge 520 includes interfacing and communication elements which can provide for coupling of SoC 510 to peripherals over connector 501, such as optional user input devices, user interface devices, printers, microphones, speakers, or other external devices and elements. In some examples, south bridge 520 includes a system management bus (SMBus) controller or other system management controller elements.

Display interfaces 522 comprise various hardware and software elements for outputting digital images, video data, audio data, or other graphical and multimedia data which can be used to render images on a display, touchscreen, or other output devices. Digital conversion equipment, filtering circuitry, image or audio processing elements, or other equipment can be included in display interfaces 522.

Network elements 534 can provide communication between computing module 500 and other computing systems or end users (not shown), which may occur over a communication network or networks and in accordance with various communication protocols, combinations of protocols, or variations thereof. Example networks include intranets, internets, the Internet, local area networks, wide area networks, wireless networks, wired networks, virtual networks, software defined networks, data center buses, computing backplanes, or any other type of network, combination of network, or variation thereof. The aforementioned communication networks and protocols are well known and need not be discussed at length here. However, some communication protocols that may be used include, but are not limited to, the Internet protocol (IP, IPv4, IPv6, etc.), the transmission control protocol (TCP), and the user datagram protocol (UDP), as well as any other suitable communication protocol, variation, or combination thereof.

Power system 560 provide operating voltages at associated current levels to at least SoC device 510. Power system 560 can convert an input voltage received over connector 501 to different output voltages or supply voltages on links 561-563, along with any related voltage regulation. Power system 560 comprises various power electronics, power controllers, DC-DC conversion circuitry, AC-DC conversion circuitry, power transistors, half-bridge elements, filters, passive components, and other elements to convert input power received through input power conditioning elements 530 over connector 501 from a power source into voltages usable by SoC device 510.

Some of the elements of power system 560 might be included in input power conditioning 530. Input power conditioning 530 can include filtering, surge protection, electromagnetic interference (EMI) protection and filtering, as well as perform other input power functions for input power 503. In some examples, input power conditioning 530 includes AC-DC conversion circuitry, such as transformers, rectifiers, power factor correction circuitry, or switching converters. When a battery source is employed as input power, then input power conditioning 530 can include various diode protection, DC-DC conversion circuitry, or battery charging and monitoring circuitry.

Power system 560 can instruct voltage regulation circuitry included therein to provide particular voltage levels for one or more voltage domains. Power system 560 can instruct voltage regulation circuitry to provide particular voltage levels for one or more operational modes, such as normal, standby, idle, and other modes. Voltage regulation circuitry can comprise adjustable output switched-mode voltage circuitry or other regulation circuitry, such as DC-DC conversion circuitry. Power system 560 can incrementally adjust output voltages provided over links 561-563 as instructed by a performance test. Links 561-563 might each be associated with a different voltage domain or power domain of SoC 510.

Power system 560 can comprise one or more microprocessors and other processing circuitry that retrieves and executes software or firmware, such as voltage control firmware and performance testing firmware, from an associated storage system. Power system 560 can be implemented within a single processing device but can also be distributed across multiple processing devices or sub-systems that cooperate in executing program instructions. Examples of power system 560 include general purpose central processing units, application specific processors, and logic devices, as well as any other type of processing device, combinations, or variations thereof. In some examples, power system 560 comprises an Intel© or AMD® microprocessor, ARM® microprocessor, FPGA, ASIC, application specific processor, or other microprocessor or processing elements.

Voltage reduction techniques are discussed in FIG. 6 for computing systems and processing devices to determine reduced operating voltages below manufacturer-specified voltages. These reduced operating voltages can lead to associated reductions in power consumption. Also, techniques and implementations illustrate various ways to employ these reduced operating voltages once determined, such as in systems having multiple computing modules assembled into a blade server arrangement with a shared fan assembly.

The voltage adjustment techniques herein exercise a system processor device, such as an SoC device, in the context of various system components of a computing assembly. These system components can include memory elements (such as random access memory or cache memory), data storage elements (such as mass storage devices), communication interface elements, peripheral devices, and power electronics elements (such as voltage regulation or electrical conversion circuitry), among others, exercised during functional testing of the processing device. Moreover, the voltage adjustment techniques herein operationally exercise internal components or portions of a processing devices, such as processing core elements, graphics core elements, north bridge elements, input/output elements, or other integrated features of the processing device.

During manufacture of processing devices, a manufacturing test can adjust various voltage settings for a manufacturer-specified operating voltage for the various associated voltage domains or voltage rails of the processing device. When placed into a computing apparatus, such as a computer, server, gaming system, or other computing device, voltage regulation elements use these manufacturer-specified operating voltages to provide appropriate input voltages to the processing device. Voltage tables might be stored in non-volatile memory and can be employed that relate portions of the processing device to manufacturer-specified operating voltages as well as to specific clock frequencies for those portions. A hard-coded frequency/voltage (F/V) table can be employed in many processing devices which might be set via fused elements to indicate to support circuitry preferred voltages for different voltage domains and operating frequencies. In some examples, these fused elements comprise voltage identifiers (VIDs) which indicate a normalized representation of the manufacturer-specified operating voltages. In addition to VID information, a TDP or power limit might be stored in non-volatile memory for later use by a control system that distributes applications for execution.

Built-in system test (BIST) circuitry can be employed to test portions of a processing device, but this BIST circuitry typically only activates a small portion of a processing device and only via dedicated and predetermined test pathways. Although BIST circuitry can test for correctness/validation of the manufacture a processing device, BIST circuitry often fails to capture manufacturing variation between devices that still meets BIST thresholds. Manufacturing variations from device to device include variations in metal width, metal thickness, insulating material thickness between metal layers, contact and via resistance, or variations in transistor electrical characteristics across multiple transistor types, and all variations can have impacts on the actual results of power consumption in functional operation. Not only do these structures vary from processing device to processing device, but they vary within a processing device based on normal process variation and photolithography differences that account for even subtle attribute differences in all these structures. As a result, the reduced operating voltages can vary and indeed may be unique on each processing device. BIST also typically produces a pass/fail result at a specific test condition. This test condition is often substantially different from real system operation for performance (and power) such that it does not accurately represent system power and performance capability of the device. With large amounts of variability between a BIST result and a functional result, the voltages employed by BIST may be found sufficient for operation but might employ significant amounts of voltage margin. In contrast to BIST testing, the functional tests described herein employ functional patterns that activate not only the entire processing device but also other components of the contextually-surrounding system that may share power domains or other elements with the processing device.

In the examples herein, functional tests are employed to determine reduced operating voltages (Vmins) for a system processor, such as SoC devices, graphics processing units (GPUs), or central processing units (CPUs). These functional tests run system-level programs which test not only a processing device, but the entire computing module in which the processing device is installed. Targeted applications can be employed which exercise the computing module and the processing device to ensure that particular processing units within the processing device are properly activated. This can include ensuring that all portions of the processing device are activated fully, a subset of units activated fully, or specific sets of background operations active in combination with targeted power-consuming operations.

The functional tests for CPU portions can include operations initiated simultaneously on all the processing cores (or a sufficient number of them to represent a ‘worst’ possible case that a user application might experience) to produce both DC power demand and AC power demand for the processing cores that replicates real-world operations. Distributed checks can be provided, such as watchdog timers or error checking and reporting elements built into the processing device, and are monitored or report alerts if a failure, crash, or system hang occurs. A similar approach can be used for the GPU, where the functional test ensures the GPU and associated graphics cores focus on high levels of graphic rendering activity to produce worst case power consumption (DC and AC), temperature rises, on-chip noise, and a sufficient number of real data paths which produce accurate operational Vmins. North bridge testing can proceed similarly, and also include memory activity between off-device memory devices and on-chip portions that are serviced by those memory devices.

The power reduction using voltage adjustment processes herein can employ voltage regulation modules (VRMs) or associated power controller circuitry with selectable supply voltage increments, where the processing device communicates with the VRMs or associated power controller circuitry to indicate the desired voltage supply values during an associated power/functional test or state in which the processing device may be operating.

Once reduced voltage values have been determined, the processing device can receive input voltages set to a desired reduced value from associated VRMs. This allows input voltages for processing devices to be set below manufacturer specified levels, leading to several technical effects. For example, associated power savings can be significant, such as 30-50 watts in some examples, and cost savings can be realized in the design and manufacturing of reduced capacity system power supplies, reductions in the VRM specifications for the processing devices, cheaper or smaller heat sinks and cooling fans. Smaller system enclosures or packaging can be employed. Additionally, the power savings can result in system characteristics that reduce electrical supply demands or battery drain.

Moreover, when many computing modules which might employ components similar to that in FIG. 5, the voltage adjustment processes can lead to lower power dissipations or current draws for given workloads for particular blade computing assemblies. For example, a first blade computing assembly with first set of computing modules can have a first blade power dissipation for a first application or first group of applications. A second blade computing assembly with a different set of computing modules of the same type or composition as the first set might have a different power dissipation for the same first application or first group of applications. This is due in part to variations in operating voltage levels determined for each computing module, such as discussed in FIG. 6.

FIG. 6 is included to illustrate operation of performance testing to determine performance properties of target integrated circuit devices in computing systems. Specifically, FIG. 6 is a flow diagram illustrating a method of operating elements of power control circuitry in an implementation. This power control circuitry can comprise elements of computing modules of each blade computing assembly in FIG. 1, control core 515 in FIG. 5, or blade management controller 591 in FIG. 5. In FIG. 6, a performance test is executed for a target integrated circuit device, such as computing module 500 and SoC device 510 in FIG. 5. For purposes of example, the operations below are executed in context with computing module 500, SoC device 510, and power system 560. In some examples, the operations of FIG. 6 can be performed by elements of FIG. 5, such as blade management controller 591. In other examples, stand-alone test equipment can be employed to performance test individual SoC devices and associated assemblies. This stand-alone test equipment can be used in a manufacturing or assembly process which individually tests SoC devices for minimum operating voltages under the performance tests. Vmin values can then be stored within voltage or power regulation control elements for subsequent usage after inclusion into blade computing assemblies or within other equipment.

A performance test can be initiated by control core 515 and executed by processing cores or processing elements of SoC device 510. SoC device 510 is typically booted into an operating system to run the performance testing of FIG. 6. During execution of the performance test on SoC device 510, input voltages will be incrementally adjusted by control core 515 and power system 560 to determine minimum functional operating voltage levels. In one example, this performance test includes incrementally adjusting at least one input voltage by initially operating one or more voltage domains of SoC device 510 at a first input voltage lower than a manufacturer specified operating voltage and progressively lowering the input voltage in predetermined increments while performing the functional test and monitoring for occurrence of the operational failures. In another example, this performance test includes incrementally adjusting at least one input voltage by initially operating one or more voltage domains of SoC device 510 at a first supply voltage lower than a manufacturer specified operating voltage and progressively raising the input voltage in predetermined increments while performing the functional test and monitoring for occurrence of the operational failures.

In manufacturing operations, a computing system comprising SoC device 510 is built and then tested individually according to a performance test. After the performance test has characterized SoC device 510 for minimum operating voltage plus any applicable voltage margin, SoC device 510 can be operated normally using these voltages. This performance test determines minimum supply voltages for proper operation of SoC device 510, which also relates to a power consumption of SoC device 510. Voltage is related to power consumption by Ohm's law and Joule's first law, among other relationships, and thus a lower operating voltage typically corresponds to a lower operating power for SoC device 510. Power consumption relates to an operating temperature, giving similar workloads for SoC device 510. Thus, the voltage adjustment method discussed in FIG. 6 allows power control circuitry to determine appropriate reduced input voltages for SoC device 510, resulting in power savings for computing module 500.

A processing device, such as SoC device 510 of FIG. 5, is incorporated into a computing system, such as computing module 500. SoC device 510 also includes many contextual assembly elements, such as seen for south bridge 520, storage elements 521, video interfaces 522, random-access memory 523, and network interfaces 524. In many examples, SoC device 510 is installed into computing module 500 during a system assembly process before testing and further assembly. Thus, the hardware and software elements included in computing module 500 are typically the actual contextual elements for operating SoC device 510 once installed into a computing system.

Control core 515 initially employs (611) default input voltages to provide power to SoC device 510. For example, control core 515 can instruct power system 560 to provide input voltages over associated power links according to manufacturer-specified operating voltages, which can be indicated by VID information stored in memory 523 or elsewhere and retrieved by control core 515. In other examples, such as when progressively rising input voltages are iteratively provided to SoC device 510, the default voltages can comprise a starting point from which to begin raising input voltage levels over time. In examples that employ incrementally rising input voltages, starting input voltages might be selected to be sufficiently low enough and less than those supplied by a manufacturer. Other default voltage levels can be employed. Once the input voltages are provided, SoC device 510 can initialize and boot into an operating system or other functional state.

An external system might transfer one or more functional tests for execution by SoC device 510 after booting into an operating system. A manufacturing system can transfer software, firmware, or instructions to control core 515 over connector 501 to initiate one or more functional tests of SoC device 510 during a voltage adjustment process. These functional tests can be received over communication interface 513 of SoC device 510 and can comprise performance tests that exercise the various integrated elements of SoC device 510 (e.g. processing cores 511 and graphics cores 512) as well as the various contextual assembly elements of SoC device 510. Portions of the voltage adjustment process or functional tests can be present before boot up to adjust input voltages for SoC device 510, such as by first initializing a first portion of SoC device 510 before initializing second portions.

Once SoC device 510 can begin executing the functional test, control core 515 drives (612) one or more performance tests on each of the power domains of SoC device 510. Power domains can each include different input voltage levels and input voltage connections power system 560. The functional tests can exercise two or more of the power domains simultaneously, which might further include different associated clock signals to run associated logic at predetermined frequencies. The functional tests can include operations initiated simultaneously on more than one processing core to produce both static/DC power demand and dynamic/AC power demand for the processing cores, graphics cores, and interfacing cores that replicates real-world operations. Moreover, the functional tests include processes that exercise elements of SoC device 510 in concert with elements 520-524, which might include associated storage devices, memory, communication interfaces, thermal management elements, or other elements.

The performance tests will typically linger at a specific input voltage or set of input voltages for a predetermined period of time, as instructed by any associated control firmware or software. This predetermined period of time allows for sufficient execution time for the functional tests to not only exercise all desired system and processor elements but also to allow any errors or failures to occur. The linger time can vary and be determined from the functional tests themselves, or set to a predetermined time based on manufacturing/testing preferences. Moreover, the linger time can be established based on past functional testing and be set to a value which past testing indicates will capture a certain population of errors/failures of system processors in a reasonable time.

If SoC device 510 does not experience failures or errors relevant to the voltage adjustment process during the linger time, then the specific input voltages employed can be considered to be sufficiently high to operate SoC device 510 successfully (613). Thus, the particular iteration of input voltage levels applied to SoC device 510 is considered a ‘pass’ and another progressively adjusted input voltage can be applied. As seen in operation (615) of FIG. 6, input voltages for SoC device 510 can be incrementally adjusted (such as lowered), SoC device 510 restarted, and the functional tests executed again for the linger time. A restart of SoC device 510 might be omitted in some examples, and further operational testing can be applied at a new input voltage level for each linger timeframe in a continuous or repeating manner. This process is repeated until either lower limits of voltage adjustment circuitry, such as power phases associated with power system 560, have been reached (614), or relevant failures of SoC device 510 or contextual components of computing module 500 are experienced. This process is employed to determine reduced operating voltages for SoC device 510 in the context of the assembly elements of computing module 500. Once voltage adjustments for the associated power domains are found, indications of these voltage adjustments can be stored for later use at voltage ‘minimums’ (Vmins) in operation 616, optionally with margins appropriate for operational ‘safety’ to reduce undiscovered failures or errors during the functional testing.

The functional tests can comprise one or more applications, scripts, or other operational test processes that bring processing cores of specific voltage domains up to desired power consumption and operation, which may be coupled with ensuring that SoC device 510 is operating at preferred temperature as well. These functional tests may also run integrity checks (such as checking mathematical computations or checksums which are deterministic and repeatable). Input voltages provided by power system 560 to SoC device 510, as specified by an associated performance test control system and communicated to control core 515, can be lowered one incremental step at a time and the functional tests run for a period of time until a failure occurs. The functional tests can automatically handle all possible failure modes resulting from lowering the voltage beyond functional levels. The possible failures include checksum errors detected at the test application level, a kernel mode crash detected by the operating system, a system hang, or hardware errors detected by system processor resulting in “sync flood” error mechanisms, among others. All failure modes can be automatically recovered from for further functional testing. To enable automatic recovery, a watchdog timer can be included and started in a companion controller, such as a “System Management Controller” (SMC), Embedded Controller, control core 515, or other control circuitry. The functional tests can issue commands to the companion controller to initialize or reset the watchdog timer periodically. If the watchdog timer expires or SoC device 510 experiences a failure mode, the companion controller can perform a system reset for computing module 500 or SoC device 510. Failure modes that result in a system reset can prompt control core 515 to initialize SoC device 510 with ‘default’ or ‘known good’ input voltage levels from power system 560. These default input voltage levels can include manufacturer specified voltages or include voltage levels associated with a most recent functional test ‘pass’ condition.

Once SoC device 510 initializes or boots after a failure during the functional tests, the failure can be noted by a failure process in the functional tests or by another entity monitoring the functional tests, such as a performance test control system or manufacturing system. The input voltage level can then be increased a predetermined amount, which might comprise one or more increments employed during the previous voltage lowering process. The increase can correspond to 2-3 increments in some examples, which might account for test variability and time-to-fail variability in the functional tests.

The voltage values determined from the voltage adjustment process can be stored (616) by control core 515 into a memory device or data structure along with other corresponding information, such as time/date of the functional tests, version information for the functional tests, or other information. Moreover, the voltage values are determined on a per-voltage domain basis, and thus are voltage values representing voltage minimums for each voltage domain are stored. Power limits, such as TDP values, based on the voltage values can also be stored into a memory device along with the voltage values. Control core 515 might store voltage values in memory 523 or in one or more data structures which indicate absolute values of voltage values or offset values of voltage values from baseline voltage values. Control core 515 might communicate the above information to an external system over a system management link, such as a manufacturing system or performance test control system. Other stored information can include power consumption peak values, average values, or ranges, along with ‘bins’ into which each computing module is categorized.

Stored voltage information can be used during power-on operations of computing module 500 to control voltage regulation circuitry of power system 560 and establish input voltage levels to be indicated by control core 515 to voltage regulation circuitry of power system 560. The resulting computing module characteristics (e.g. power levels and thermal attributes) are substantially improved after the voltage adjustment process is completed. Thus, the voltage adjustment process described above allows systems to individually determine appropriate reduced operating voltages for voltage regulation circuitry of power system 560 during a manufacturing or integration testing process, and for testing performed in situ after manufacturing occurs. Testing can be performed to determine changes in minimum operating voltages after changes are detected to SoC device 510, contextual elements 520-524, or periodically after a predetermined timeframe.

The iterative voltage search procedure can be repeated independently for each power domain and for each power state in each domain where power savings are to be realized. For example, a first set of functional tests can be run while iteratively lowering an input voltage corresponding to a first voltage/power domain of SoC device 510. A second set of functional tests can then be run while iteratively lowering a second input voltage corresponding to a second voltage/power domain of SoC device 510. When the second set of functional tests are performed for the second input voltage, the first voltage can be set to a value found during the first functional tests or to a default value, among others.

Advantageously, end-of-life (EoL) voltage margin need not be added during manufacturing test or upon initial shipment of computing module 500. EoL margin can be added if desired, such as 10 to 50 millivolts (mV), among other values, or can be added after later in-situ testing described below. EoL margins are typically added in integrated circuit systems to provide sufficient guardband as associated silicon timing paths in the integrated circuit slow down over time with use. Although the amount of margin typically employed for EoL is only perhaps 15-30 mV (depending upon operating conditions, technology attributes, and desired life time), the systems described herein can eliminate this margin initially, either partially or entirely. In some examples, an initial voltage margin is employed incrementally above the Vmin at an initial time, and later, as the system operates during normal usage, further EoL margin can be incrementally added proportional to the total operational time (such as in hours) of a system or according to operational time for individual voltage domains. Thus, extra voltage margin is recovered from SoC device 510 after the initial voltage adjustment process, and any necessary margin for EoL can be staged back over the operational lifetime of SoC device 510. Moreover, by operating a user system at lower voltages for a longer period of time, system reliability is further improved. These benefits might taper off over the course of time as the EoL margin is staged back in, but it will improve the initial experience.

FIG. 6 also illustrates graph 650 that show how a voltage adjustment process might progress. Graph 650 can illustrate one example voltage minimization operation for operation 615 of FIG. 6. Graph 650 shows a ‘downward’ incremental Vmin search using progressively lowered voltages, with safety margin added at the end of the process to establish an operational voltage, V_{P}. Later margin (V_{EOL}) can be staged in to account for EoL concerns. Specifically, graph 650 shows a default or initial voltage level V₀ applied to SoC device 510. After a linger time for a functional test, a successful outcome prompts an incremental lowering to V₁ and retesting under the functional test. Further incremental lowering can be performed for each successful iteration of the functional test for an associated time indicated in graph 650. Finally, a lowest or reduced operating voltage is found at V₃ and optional margin is applied to establish V_{OP}. V_{OP} is employed for the normal operation of the system processor for a period of operational time indicated by t₅. This time can occur while an associated system is deployed on-site. After a designated number of hours indicated by t₅, EoL margin can be staged in to established V_{EOL}. Multiple stages of EoL margin can occur, although only one is shown in graph 650 for clarity.

The voltage levels indicated in graph 650 can vary and depend upon the actual voltage levels applied to a system processor. For example, for a voltage domain of SoC device 510 operating around 0.9V, a reduced voltage level can be discovered using the processes in graph 650. Safety margin of 50 mV might be added in graph 650 to establish V_{OP} and account for variation in user applications and device aging that will occur over time. However, depending upon the operating voltage, incremental step size, and aging considerations, other values could be chosen. In contrast to the downward voltage search in graph 650, an upward voltage search process can instead be performed. An upward voltage search process uses progressively raised voltages to establish an operational voltage, V_{OP}. Later margin (V_{EOL}) can be staged in to account for EoL concerns.

The processes in graph 650 can be executed independently for each power supply phase or power domain associated with SoC device 510. Running the procedure on one power supply phase or power domain at a time can allow for discrimination of which power supply phase or power domain is responsible for a system failure when looking for the Vmin of each domain. However, lowering multiple voltages for power supply phases or power domains at the same time can be useful for reducing test times, especially when failures can be distinguished in other ways among the various power supply phases or power domains. In further examples, a ‘binary’ voltage adjustment/search algorithm can be used to find the Vmin by reducing the voltage halfway to an anticipated Vmin as opposed to stepping in the increments of graph 650. In such examples, a Vmin further testing might be needed by raising the voltage once a failure occurred and successfully running system tests at that raised value. Other voltage adjustment/search techniques could be used and the techniques would not deviate from the operations to establish a true Vmin in manufacturing processes that can then be appropriately adjusted to provide a reasonable margin for end user operation.

FIG. 7 illustrates control system 710 that is representative of any system or collection of systems from which the various power characterization, performance testing, and workload management can be directed. Any of the operational architectures, platforms, scenarios, and processes disclosed herein may be implemented using elements of control system 710. Examples of control system 710 include, but are not limited to, management agents, workload managers, top-of-rack equipment, or other devices.

Control system 710 may be implemented as a single apparatus, system, or device or may be implemented in a distributed manner as multiple apparatuses, systems, or devices. Control system 710 includes, but is not limited to, processor 711, storage system 713, communication interface system 714, and firmware 720. Processor 711 is operatively coupled with storage system 713 and communication interface system 714.

Processor 711 loads and executes firmware 720 from storage system 713. When executed by processor 711 to enhance testing, assembly, or manufacturing of server equipment, firmware 720 directs processor 711 to operate as described herein for at least the various processes, operational scenarios, and sequences discussed in the foregoing implementations. Control system 710 may optionally include additional devices, features, or functionality not discussed for purposes of brevity.

Processor 711 may comprise a microprocessor and processing circuitry that retrieves and executes firmware 720 from storage system 713. Processor 711 may be implemented within a single processing device, but may also be distributed across multiple processing devices, sub-systems, or specialized circuitry, that cooperate in executing program instructions and in performing the power characterization, performance testing, and workload management operations discussed herein. Examples of processor 711 include general purpose central processing units, application specific processors, and logic devices, as well as any other type of processing device, combinations, or variations thereof.

Storage system 713 may comprise any computer readable storage media readable by processor 711 and capable of storing firmware 720. Storage system 713 may include volatile and nonvolatile, removable and non-removable media implemented in any method or technology for storage of information, such as computer readable instructions, data structures, program modules, or other data. Examples of storage media include random access memory (RAM), read only memory, magnetic disks, optical disks, flash memory, virtual memory and non-virtual memory, magnetic cassettes, magnetic tape, magnetic disk storage or other magnetic storage devices, or any other suitable storage media. In no case is the computer readable storage media a propagated signal.

In addition to computer readable storage media, in some implementations storage system 713 may also include computer readable communication media over which at least some of firmware 720 may be communicated internally or externally. Storage system 713 may be implemented as a single storage device, but may also be implemented across multiple storage devices or sub-systems co-located or distributed relative to each other. Storage system 713 may comprise additional elements, such as a controller, capable of communicating with processor 711 or possibly other systems.

Firmware 720 may be implemented in program instructions and among other functions may, when executed by processor 711, direct processor 711 to operate as described with respect to the various operational scenarios, sequences, and processes illustrated herein. For example, firmware 720 may include program instructions for enhanced power characterization, performance testing, and workload management operations, among other operations.

In particular, the program instructions may include various components or modules that cooperate or otherwise interact to carry out the various processes and operational scenarios described herein. The various components or modules may be embodied in compiled or interpreted instructions, or in some other variation or combination of instructions. The various components or modules may be executed in a synchronous or asynchronous manner, serially or in parallel, in a single threaded environment or multi-threaded, or in accordance with any other suitable execution paradigm, variation, or combination thereof. Firmware 720 may include additional processes, programs, or components, such as operating system software or other application software, in addition to that of manufacturing control 721. Firmware 720 may also comprise program code, scripts, macros, and other similar components. Firmware 720 may also comprise software or some other form of machine-readable processing instructions executable by processor 711.

In general, firmware 720 may, when loaded into processor 711 and executed, transform a suitable apparatus, system, or device (of which control system 710 is representative) overall from a general-purpose computing system into a special-purpose computing system customized to facilitate enhanced power characterization, performance testing, and workload management operations. Indeed, encoding firmware 720 on storage system 713 may transform the physical structure of storage system 713. The specific transformation of the physical structure may depend on various factors in different implementations of this description. Examples of such factors may include, but are not limited to, the technology used to implement the storage media of storage system 713 and whether the computer-storage media are characterized as primary or secondary storage, as well as other factors.

For example, if the computer readable storage media are implemented as semiconductor-based memory, firmware 720 may transform the physical state of the semiconductor memory when the program instructions are encoded therein, such as by transforming the state of transistors, capacitors, or other discrete circuit elements constituting the semiconductor memory. A similar transformation may occur with respect to magnetic or optical media. Other transformations of physical media are possible without departing from the scope of the present description, with the foregoing examples provided only to facilitate the present discussion.

Firmware 720 can include one or more software elements, such as an operating system, devices drivers, and one or more applications. These elements can describe various portions of control system 710 with which other elements interact. For example, an operating system can provide a software platform on which firmware 720 is executed and allows for enhanced power characterization, performance testing, and workload management operations, among other operations.

Blade characterization 722 determines power limits for computing modules of a plurality of blade computing assemblies. These power limits can be determined in the aggregate for an entire blade computing assembly, or might be determined for individual computing modules that comprise a blade computing assembly. Typically, power limits are established based at least on performance tests executed on each of the computing modules of the plurality of blade computing assemblies.

In one example, blade characterization 722 is configured to direct execution of a performance test on a plurality of computing modules to determine at least variability in power efficiency across the plurality of computing modules which are contained in one or more blade computing assemblies. The performance test can be executed on each of a plurality of computing modules to determine minimum operating voltages lower than a manufacturer specified operating voltage for at least one supply voltage common to the plurality of computing modules. Transfer of the performance test to each computing module can occur over links 781-782 or other links. The performance test can comprise computer-readable instructions stored within storage system 713. The performance test might comprise a system image or bootable image which includes an operating system, applications, performance tests, voltage regulator control instructions, and other elements which are transferred over link 781-782 to a target computing module under test.

In some examples, a performance test portion of blade characterization 722 for computing modules comprises iteratively booting a processing device of a target computing module into an operating system after reducing a voltage level of at least one supply voltage applied to at least one voltage domain of the target computing module. For each reduction in the at least one supply voltage, the performance test includes executing a voltage characterization service to perform one or more functional tests that run one or more application level processes in the operating system and exercise processor core elements and interface elements of the processing device in context with a plurality of elements external to the processing device on the target computing module which share the at least one supply voltage. The performance test also includes monitoring for operational failures of at least the processing device during execution of the voltage characterization service, and based at least on the operational failures, determining at least one resultant supply voltage, wherein the at least one resultant supply voltage relates to a power consumption for the target computing module. Iterative booting of the processing device of the target computing module can comprise establishing a minimum operating voltage for the at least one supply voltage based on a current value of the iteratively reduced voltages, adding a voltage margin to the minimum operating voltage to establish the at least one resultant supply voltage, and instructing voltage regulator circuitry of the target computing module to supply the at least one resultant supply voltage to the processing device for operation of the processing device.

Application characterization 723 determines how much power each of a set of applications, such as games or productivity applications, uses to execute. A representative execution system or systems can be used to determine statistically relevant power demands, such as an average power demand, peak power demand, or other measured power demand for each application. Application characterization 723 then stores measurements or values for each application power demand in storage system 713. This characterization is done before workload management agent 724 receives requests for execution of the applications, and thus application characterization occurs based on prior-executed applications on representative systems. Power demands can be updated in real-time by monitoring application execution on one or more blade computing assemblies, which might aid in determining statistically sampled power demands over time. Application characterization 723 can also normalize the power demands. In one example, application characterization 723 normalizes the power demands from the prior execution of each of the plurality of applications to a metric or percentage of a power limit metric to establish the estimated power demands.

Workload management agent 724 receives requests for execution of applications by a computing system, and distributes execution tasks for the plurality of applications to a plurality of blade computing assemblies within the computing system. Workload management agent 724 can receive incoming task requests that are received by control system 710 over communication interface 714 and link 780. Workload management agent 724 determines power limits for computing modules in a plurality of blade computing assemblies capable of executing the plurality of applications, and selects among the plurality of computing modules to execute ones of the plurality of applications based at least on the power limits and the estimated power demands. The power limits can be normalized to the same metric as the application power demands. Workload management agent 724 can determine power limits based at least on a performance test executed by each of the plurality of computing modules. Workload management agent 724 can distribute assigned task requests to individual computing modules of the blade computing assemblies over communication interface 714 and link 781.

In further examples, workload management agent 724 selects among the plurality of blade computing assemblies to execute ones of the plurality of applications based at least on proximity to a ventilation airflow input to a rackmount computing system. In yet further examples, workload management agent 724 can distribute for execution ones of the plurality of applications having higher estimated power demands to ones of the plurality of similarly provisioned computing modules having lower processor core voltages.

Communication interface system 714 may include communication connections and devices that allow for communication over links 780-782 with other computing systems (not shown) over communication networks (not shown). Examples of connections and devices that together allow for inter-system communication may include network interface controllers, antennas, power amplifiers, RF circuitry, transceivers, and other communication circuitry. The connections and devices may communicate over communication media to exchange packetized communications with other computing systems or networks of systems, such as metal, glass, air, or any other suitable communication media. Communication interface system 714 may include user interface elements, such as programming registers, status registers, control registers, APIs, or other user-facing control and status elements.

Communication between control system 710 and other systems (not shown), may occur over a links 780-782 comprising a communication network or networks and in accordance with various communication protocols, combinations of protocols, or variations thereof. These other systems can include manufacturing systems, such as testing equipment, assembly equipment, sorting equipment, binning equipment, pick-and-place equipment, soldering equipment, final assembly equipment, or inspection equipment, among others. Communication interfaces might comprise system management bus (SMBus) interfaces, inter-integrated circuit (I2C) interfaces, or other similar interfaces. Further examples include intranets, internets, the Internet, local area networks, wide area networks, wireless networks, wired networks, virtual networks, software defined networks, data center buses, computing backplanes, or any other type of network, combination of network, or variation thereof. The aforementioned communication networks and protocols are well known and need not be discussed at length here. However, some communication protocols that may be used include, but are not limited to, the Internet protocol (IP, IPv4, IPv6, etc.), the transmission control protocol (TCP), and the user datagram protocol (UDP), as well as any other suitable communication protocol, variation, or combination thereof.

Certain inventive aspects may be appreciated from the foregoing disclosure, of which the following are various examples.

Example 1: A method of operating a data processing system, comprising receiving requests for execution of a plurality of applications, identifying estimated power demands for execution of each of the plurality of applications, and determining power limit properties for a plurality of computing modules capable of executing the plurality of applications. The method also includes selecting among the plurality of computing modules to execute ones of the plurality of applications based at least on the power limit properties and the estimated power demands.

Example 2: The method of Example 1, further comprising determining the estimated power demands for each of the plurality of applications based at least on monitored power consumption during prior execution of each of the plurality of applications on one or more representative computing devices.

Example 3: The method of Examples 1-2, further comprising normalizing the power consumption from the prior execution of each of the plurality of applications to a percentage of a metric to establish the estimated power demands, wherein the power limit properties are normalized to the metric.

Example 4: The method of Examples 1-3, wherein the power limit properties are determined for each of the computing modules based at least on a performance test executed by each of the plurality of computing modules that determines reduced operating voltages for at least processing elements of the plurality of computing modules below a manufacturer specified operating voltage.

Example 5: The method of Examples 1-4, further comprising receiving the requests into a workload manager for a rackmount computing system, and distributing execution tasks for the plurality of applications to the plurality of computing modules comprising blade computing assemblies within the rackmount computing system.

Example 6: The method of Examples 1-5, further comprising further selecting among the plurality of computing modules to execute ones of the plurality of applications based at least on proximity of associated blade computing assemblies to a ventilation airflow input to the rackmount computing system.

Example 7: The method of Examples 1-6, wherein each of the plurality of computing modules have corresponding power limit properties, and wherein sets of the plurality of computing modules are selected for inclusion into associated blade computing assemblies based at least on achieving an average power dissipation target for each of the blade computing assemblies.

Example 8: The method of Examples 1-7, wherein each of the plurality of computing modules comprise a plurality of similarly provisioned computing modules that differ among processor core voltages determined from one or more performance tests executed on the plurality of similarly provisioned computing modules.

Example 9: The method of Examples 1-8, further comprising distributing for execution first ones of the plurality of applications having higher estimated power demands to first ones of the plurality computing modules having lower power limit properties, and distributing for execution second ones of the plurality of applications having lower estimated power demands to second ones of the plurality of computing modules having higher power limit properties.

Example 10: A data processing system, comprising a network interface system configured to receive requests for execution of applications, and a control system. The control system is configured to identify estimated power demands for execution of each of the applications, and determine power limit properties for a plurality of computing modules capable of executing the applications. The control system is configured to select among the plurality of computing modules to handle execution of the applications based at least on the power limit properties and the estimated power demands, and distribute indications of the requests to selected computing modules.

Example 11: The data processing system of Example 10, wherein the estimated power demands for each of the applications are determined by at least monitoring power consumption during prior execution of the applications on one or more representative computing devices.

Example 12: The data processing system of Examples 10-11, comprising the control system configured to normalize the power consumption from the prior execution to a percentage of a metric to establish the estimated power demands, wherein the power limit properties are normalized to the metric.

Example 13: The data processing system of Examples 10-12, wherein the power limit properties are each determined for each of the computing modules based at least on a performance test executed by each of the plurality of computing modules that determines reduced operating voltages for at least processing elements of the plurality of computing modules below a manufacturer specified operating voltage.

Example 14: The data processing system of Examples 10-13, comprising the network interface system configured to receive the requests into a workload manager for a rackmount computing system, and distribute execution tasks for the applications to the plurality of computing modules comprising blade computing assemblies within the rackmount computing system.

Example 15: The data processing system of Examples 10-14, comprising the control system configured to further select among the plurality of computing modules to execute ones of the applications based at least on proximity of associated blade computing assemblies to a ventilation airflow input to the rackmount computing system.

Example 16: The data processing system of Examples 10-15, wherein each of the plurality of computing modules have corresponding power limit properties, and wherein each of the plurality of blade assemblies comprises a plurality of computing modules each comprising a processing system capable of executing the applications.

Example 17: The data processing system of Examples 10-16, wherein each of the plurality of computing modules comprise a plurality of similarly provisioned computing modules that differ among processor core voltages determined from one or more performance tests executed on the plurality of similarly provisioned computing modules.

Example 18: The data processing system of Examples 10-17, comprising the control system configured to distribute for execution first ones of the applications having higher estimated power demands to first ones of the plurality of computing modules having lower power limit properties. The control system is configured to distribute for execution second ones of the plurality of applications having lower estimated power demands to second ones of the plurality of computing modules having higher power limit properties.

Example 19: An apparatus comprising one or more computer readable storage media, and program instructions stored on the one or more computer readable storage media. Based at least in part on execution by a control system, the program instructions direct the control system to at least receive requests for execution of applications in a data center identify estimated power demands for execution of each of the applications, and determine thermal design power (TDP) limits for a plurality of computing modules capable of executing the applications. The program instructions further direct the control system to select among the plurality of computing modules to execute ones of the applications based at least on the TDP limits and the estimated power demands, and distribute tasks for execution of the applications to selected computing modules.

Example 20: The apparatus of Example 19, wherein the estimated power demands for each of the applications are determined by at least monitoring power consumption during prior execution of the applications on one or more computing devices. The program instructions further direct the control system to normalize the power consumption from the prior execution to a percentage of TDP of the one or more computing devices to establish the estimated power demands, and determine the TDP limits based on characterized operating voltages for processing elements of the plurality of computing modules established at levels below manufacturer specified levels resultant from one or more performance tests executed by the plurality of computing modules.

The functional block diagrams, operational scenarios and sequences, and flow diagrams provided in the Figures are representative of exemplary systems, environments, and methodologies for performing novel aspects of the disclosure. While, for purposes of simplicity of explanation, methods included herein may be in the form of a functional diagram, operational scenario or sequence, or flow diagram, and may be described as a series of acts, it is to be understood and appreciated that the methods are not limited by the order of acts, as some acts may, in accordance therewith, occur in a different order and/or concurrently with other acts from that shown and described herein. For example, those skilled in the art will understand and appreciate that a method could alternatively be represented as a series of interrelated states or events, such as in a state diagram. Moreover, not all acts illustrated in a methodology may be required for a novel implementation.

The descriptions and figures included herein depict specific implementations to teach those skilled in the art how to make and use the best option. For the purpose of teaching inventive principles, some conventional aspects have been simplified or omitted. Those skilled in the art will appreciate variations from these implementations that fall within the scope of the invention. Those skilled in the art will also appreciate that the features described above can be combined in various ways to form multiple implementations. As a result, the invention is not limited to the specific implementations described above, but only by the claims and their equivalents.

What is claimed is:

1. A method of operating a data processing system, comprising:
receiving requests for execution of a plurality of applications;
identifying estimated power demands for execution of each of the plurality of applications;
determining power limit properties for a plurality of computing modules capable of executing the plurality of applications; and
selecting among the plurality of computing modules to execute ones of the plurality of applications based at least on the power limit properties and the estimated power demands.

2. The method of claim 1, further comprising:
determining the estimated power demands for each of the plurality of applications based at least on monitored power consumption during prior execution of each of the plurality of applications on one or more representative computing devices.

3. The method of claim 2, further comprising:
normalizing the power consumption from the prior execution of each of the plurality of applications to a percentage of a metric to establish the estimated power demands, wherein the power limit properties are normalized to the metric.

4. The method of claim 1, wherein the power limit properties are determined for each of the computing modules based at least on a performance test executed by each of the plurality of computing modules that determines reduced operating voltages for at least processing elements of the plurality of computing modules below a manufacturer specified operating voltage.

5. The method of claim 1, further comprising:
receiving the requests into a workload manager for a rackmount computing system, and distributing execution tasks for the plurality of applications to the plurality of computing modules comprising blade computing assemblies within the rackmount computing system.

6. The method of claim 5, further comprising:
further selecting among the plurality of computing modules to execute ones of the plurality of applications based at least on proximity of associated blade computing assemblies to a ventilation airflow input to the rackmount computing system.

7. The method of claim 1, wherein each of the plurality of computing modules have corresponding power limit properties, and wherein sets of the plurality of computing modules are selected for inclusion into associated blade computing assemblies based at least on achieving an average power dissipation target for each of the blade computing assemblies.

8. The method of claim 1, wherein each of the plurality of computing modules comprise a plurality of similarly provisioned computing modules that differ among processor core voltages determined from one or more performance tests executed on the plurality of similarly provisioned computing modules.

9. The method of claim 1, further comprising:
distributing for execution first ones of the plurality of applications having higher estimated power demands to first ones of the plurality computing modules having lower power limit properties; and
distributing for execution second ones of the plurality of applications having lower estimated power demands to second ones of the plurality of computing modules having higher power limit properties.

10. A data processing system, comprising:
a network interface system configured to receive requests for execution of applications; and
a control system configured to:
identify estimated power demands for execution of each of the applications;
determine power limit properties for a plurality of computing modules capable of executing the applications;
select among the plurality of computing modules to handle execution of the applications based at least on the power limit properties and the estimated power demands; and
distribute indications of the requests to selected computing modules.

11. The data processing system of claim 10, wherein the estimated power demands for each of the applications are determined by at least monitoring power consumption during prior execution of the applications on one or more representative computing devices.

12. The data processing system of claim 11, comprising:
the control system configured to normalize the power consumption from the prior execution to a percentage of a metric to establish the estimated power demands, wherein the power limit properties are normalized to the metric.

13. The data processing system of claim 10, wherein the power limit properties are each determined for each of the computing modules based at least on a performance test executed by each of the plurality of computing modules that determines reduced operating voltages for at least processing elements of the plurality of computing modules below a manufacturer specified operating voltage.

14. The data processing system of claim 10, comprising:
the network interface system configured to receive the requests into a workload manager for a rackmount computing system, and distribute execution tasks for the applications to the plurality of computing modules comprising blade computing assemblies within the rackmount computing system.

15. The data processing system of claim 14, comprising:
the control system configured to further select among the plurality of computing modules to execute ones of the applications based at least on proximity of associated blade computing assemblies to a ventilation airflow input to the rackmount computing system.

16. The data processing system of claim 10, wherein each of the plurality of computing modules have corresponding power limit properties, and wherein each of the plurality of blade assemblies comprises a plurality of computing modules each comprising a processing system capable of executing the applications.

17. The data processing system of claim 10, wherein each of the plurality of computing modules comprise a plurality of similarly provisioned computing modules that differ among processor core voltages determined from one or more performance tests executed on the plurality of similarly provisioned computing modules.

18. The data processing system of claim 10, comprising:
the control system configured to distribute for execution first ones of the applications having higher estimated power demands to first ones of the plurality of computing modules having lower power limit properties; and
the control system configured to distribute for execution second ones of the plurality of applications having lower estimated power demands to second ones of the plurality of computing modules having higher power limit properties.

19. An apparatus comprising:
one or more computer readable storage media;
program instructions stored on the one or more computer readable storage media that, based at least in part on execution by a control system, direct the control system to at least:
receive requests for execution of applications in a data center;
identify estimated power demands for execution of each of the applications;
determine thermal design power (TDP) limits for a plurality of computing modules capable of executing the applications;
select among the plurality of computing modules to execute ones of the applications based at least on the TDP limits and the estimated power demands; and
distribute tasks for execution of the applications to selected computing modules.

20. The apparatus of claim 19, wherein the estimated power demands for each of the applications are determined by at least monitoring power consumption during prior execution of the applications on one or more computing devices, and comprising further program instructions, based at least in part on execution by the control system, direct the control system to at least:
normalize the power consumption from the prior execution to a percentage of TDP of the one or more computing devices to establish the estimated power demands; and
determine the TDP limits based on characterized operating voltages for processing elements of the plurality of computing modules established at levels below manufacturer specified levels resultant from one or more performance tests executed by the plurality of computing modules.
